(19) United States
(12) Patent Application Publication
(10) Pub. No.: US 2026/0005241 A1
(43) Pub. Date: Jan. 1, 2026

(54) Chalcogenide Blends For Rechargeable Battery Cathode Materials

(71) Applicant: The Government of the Unites States of America, as represented by the Secretary of the Navy, Arlington, VA (US)

(72) Inventors: Darryl A. Boyd, Ft. Washington, MD (US); Vinh Q. Nguyen, Fairfax, VA (US); Corey T. Love, Alexandria, VA (US); Woohong Kim, Lorton, VA (US); Jasbinder S. Sanghera, Ashburn, VA (US); Rachel C. Ashmore, Washington, DC (US)

(73) Assignee: The Government of the Unites States of America, as represented by the Secretary of the Navy, Arlington, VA (US)

(21) Appl. No.: 19/234,068

(22) Filed: Jun. 10, 2025

Related U.S. Application Data
(60) Provisional application No. 63/666,021, filed on Jun. 28, 2024.

(51) Int. Cl. H01M 4/58; H01M 4/36; H01M 4/587

(52) U.S. Cl. CPC H01M 4/5815; H01M 4/366; H01M 4/587

(57) ABSTRACT

A chalcogenide blend for a rechargeable battery cathode material comprising a chalcogen material, and a carbon paper, wherein the chalcogen material is incorporated into the carbon paper to form a rechargeable battery cathode material. A method of making a chalcogenide blend for rechargeable battery cathode material comprising the steps of blending elemental sulfur and selenium to form a Sulfur-Selenium blend chalcogen powder, purifying the Sulfur-Selenium blend chalcogen powder, and incorporating the Sulfur-Selenium blend chalcogen powder into a porous carbon scaffold.

### REFERENCE TO RELATED APPLICATION

This application is a non-provisional of, and claims priority to and the benefits of, U.S. Provisional Patent Application No. 63/666,021 filed on Jun. 28, 2024, the entirety of which is herein incorporated by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case #212204.

### BACKGROUND

This disclosure concerns a process to fabricate rechargeable battery cathodes using chalcogenide blend materials that are vapor loaded into carbon papers.

These new battery cathode materials are composed of multicomponent chalcogenide elements such as sulfur and/or selenium and/or tellurium that determine the overall electronic properties of the battery.

Our new material is ideally suitable for use as a cathode material in rechargeable battery technology such as lithium-sulfur and sodium-sulfur batteries where conventional chalcogen-based cathode materials have failed due to presumed chalcogen shuttling effects.

This new material's properties can be controlled by tuning the atomic ratios of the various chalcogen components in the blended polycrystalline material, while also tuning the scaffold and cell components.

Along with detailing the synthesis and fabrication of our rechargeable battery cathode material, we provide data for several iterations of these materials in functioning coin-cell batteries.

Rechargeable battery technology is ubiquitous and essential for powering devices utilized in every day modern life. Lithium-ion (Li⁺) battery technology has seen broad usage for more than 3 decades due to its long cycle life, and its pioneers garnered the 2019 Nobel Prize in Chemistry.

Despite its broad usage, Li⁺ battery technology suffers from serious safety concerns, as well as increasingly limited resources for the components used in Li⁺ battery fabrication.

Sulfur is a byproduct of oil and gas refinement, leaving much of the element around as waste globally. Sulfur has the capacity to store 10× the amount of Li⁺ compared to conventional intercalation cathodes (CoO₂, NMC, etc). However, the system is not widely adopted because it does not exhibit the long cycle-life that Li⁺ does in commercial batteries.

Most of the cycling and charge and/or discharge rate challenges arise from sulfur being an insulator, so to facilitate charging and discharging, passive conductive components are required.

Herein, we demonstrate a solution to these long-standing problems.

Selenium is an interesting fit as an additional conducting component for sulfur in rechargeable battery systems, since it will also react with lithium and contribute energy to the system and not just act passively. This is because both sulfur and selenium are members of Group 16 on the Periodic Table of the Elements, meaning that they share several key similarities. As a result, these elements can be readily blended together.

Most importantly, selenium is several orders of magnitude more electrically conductive than sulfur.

Our invention employs a combination of sulfur-selenium (S—Se) chalcogenide blends uniquely combined with carbon nanofoam papers, lithium, and electrolyte to result in functional rechargeable batteries that feature S—Se blends within the battery cathode.

The resulting batteries provide improved cycle life and high charge and/or discharge rate capability compared to pure S cathodes.

The disclosed comprehensive approach will produce a new battery chemistry for advanced power and energy.

### SUMMARY OF DISCLOSURE

This disclosure concerns a process to fabricate rechargeable battery cathodes using chalcogenide blend materials that are vapor loaded into carbon papers.

These new battery cathode materials are composed of multicomponent chalcogenide elements such as sulfur and/or selenium and/or tellurium that determine the overall electronic properties of the battery.

Our new material is ideally suitable for use as a cathode material in rechargeable battery technology such as lithium-sulfur and sodium-sulfur batteries where conventional chalcogen-based cathode materials have failed due to presumed chalcogen shuttling effects.

This new material's properties can be controlled by tuning the atomic ratios of the various chalcogen components in the blended polycrystalline material, while also tuning the scaffold and cell components.

Along with detailing the synthesis and fabrication of our rechargeable battery cathode material, we provide data for several iterations of these materials in functioning coin-cell batteries.

Herein, we demonstrate a solution to the long-standing problems discussed above.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1 illustrates an ampoule containing S95Ses crystalline compound.

FIG. 2 illustrates various sulfur and selenium blend materials. Sulfur: Selenium ratios are designated in the image for each blend.

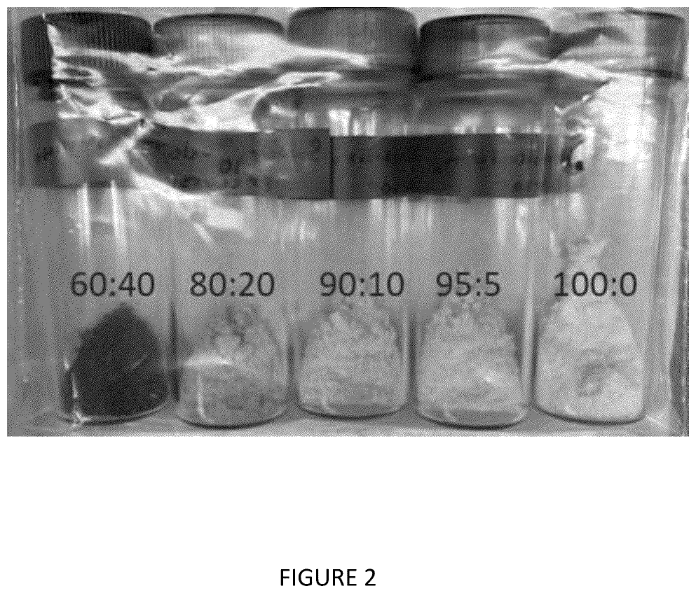

FIG. 3 illustrates TGA/DSC of 60/40 SSe blend. Vapor infiltration temperature selected between melt point (˜110° C.) and burning point (˜300° C.).

FIG. 4 illustrates Lithium capacity per cycle showing enhanced stability for 60/40 S/Se cathode compared to higher initial capacity for pure sulfur and the 95/5 S/Te cathode but with steady capacity loss.

FIG. 5 illustrates discharge capacity of S/Se@CNFP electrodes normalized to the active chalcogenide mass as a function of C-rate where 1 C correlates to a 1 hour charge.

### DETAILED DESCRIPTION OF THE INVENTION

This disclosure concerns a process to fabricate rechargeable battery cathodes using chalcogenide blend materials that are vapor loaded into carbon papers.

These new battery cathode materials are composed of multicomponent chalcogenide elements such as sulfur and/or selenium and/or tellurium that determine the overall electronic properties of the battery.

Our new material is ideally suitable for use as a cathode material in rechargeable battery technology such as lithium-sulfur and sodium-sulfur batteries where conventional chalcogen-based cathode materials have failed due to presumed chalcogen shuttling effects.

This new material's properties can be controlled by tuning the atomic ratios of the various chalcogen components in the blended polycrystalline material, while also tuning the scaffold and cell components.

Along with detailing the synthesis and fabrication of our rechargeable battery cathode material, we provide data for several iterations of these materials in functioning coin-cell batteries.

The current Lithium batteries suffer from serious safety issues and increasingly limited resources.

Our chalcogenide blends for rechargeable battery cathode materials overcome the safety issues and limited resources issues of traditional lithium batteries.

In this disclosure, we describe a process to fabricate a rechargeable battery cathode that incorporates chalcogenide blend materials to deliver equivalent (or greater) power and cycling than conventional chalcogen materials currently available.

This fabrication method makes this material suitable for low-cost, easily processed battery cathodes.

### Example 1

The chalcogenide materials are composed of sulfur and selenium that are seamlessly mixed in varying proportions to afford tunable battery power and cycling outputs.

The synthesis of this cathode is carried out in a two-step process.

In the first step a sulfur/selenium crystalline blend is synthesized to form a chalcogenide blend.

In the second step the chalcogenide blend is vapor deposited onto carbon electrolyte and incorporated into a battery matrix.

Herein we also include disclosure to cathodes utilizing blends of chalcogen materials with non-chalcogen elements (e.g. germanium, tin, antimony, etc.). Finally, we include several examples of products that are made with this new material and process.

### Example 2

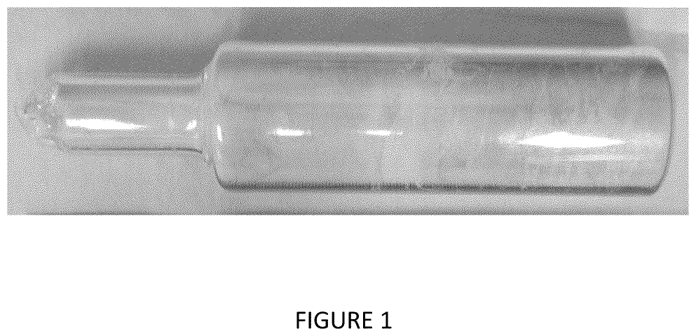

Elemental sulfur and selenium are blended together in various proportions (FIGS. 1 & 2) as previously described.

Chalcogen powders (S, Se) were purified via multi-chamber distillation, as reported by Boyd et al. Vapor-deposition protocols were adapted from those previously used to incorporate sulfur into porous carbon scaffolds.

### Example 3

Carbon nanofoam paper (CNFP) electrodes-“40/300” formulation, dictating precursor quantities-were cut to size and then placed into a PTFE infiltration chamber.

The chamber bottom has a well into which was placed ˜1 g of the chalcogen powder to be infiltrated (i.e. sulfur, selenium, or a 60/40 atomic ratio blend of sulfur/selenium), with the CNFP substrate suspended on a stainless-steel mesh above.

After sealing, this chamber was then placed into a small muffle furnace for vapor infiltration.

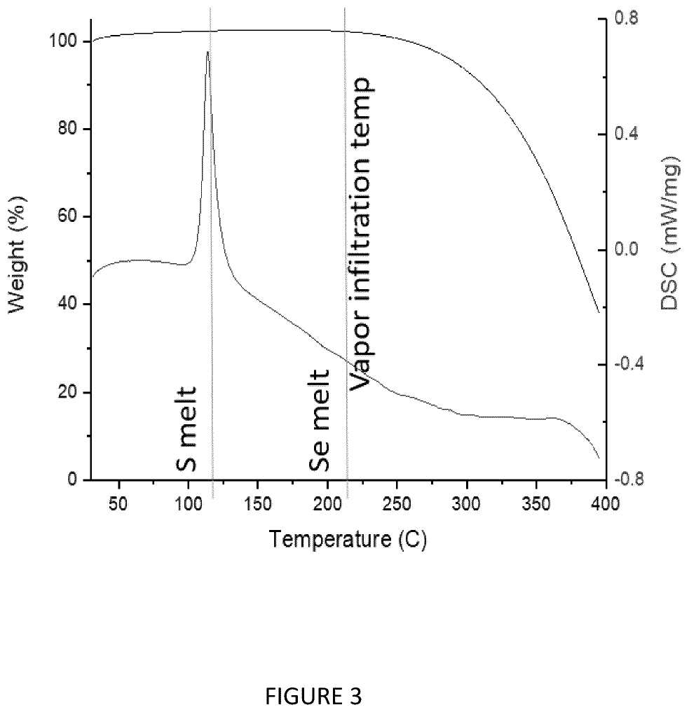

Temperatures vary depending upon the infiltrating material, and are selected from Differential Scanning calorimetry (DSC) and thermogravimetric analysis (TGA) of each sample type, illustrated in FIG. 3.

For the 60/40 blend, 225° C. was utilized.

Infiltrations are varied to achieve the desired loading of the samples.

Chalcogenide mass loadings were determined by taking CNFP electrode mass before and after infiltration.

### Example 4

Galvanostatic cycling of 2032-coin cells was used to assess lithium storage capacity of the cathodes.

In an Ar-filled glovebox, chalcogen@CNFP cathodes were covered with Entek “Gold” separator wetted with 80 μL of 1M lithium bis(trifluoromethanesulfonyl)imide (LiTFSI), 0.2M LiNO₃ DOL: DME, and then a Li metal chip (MTI).

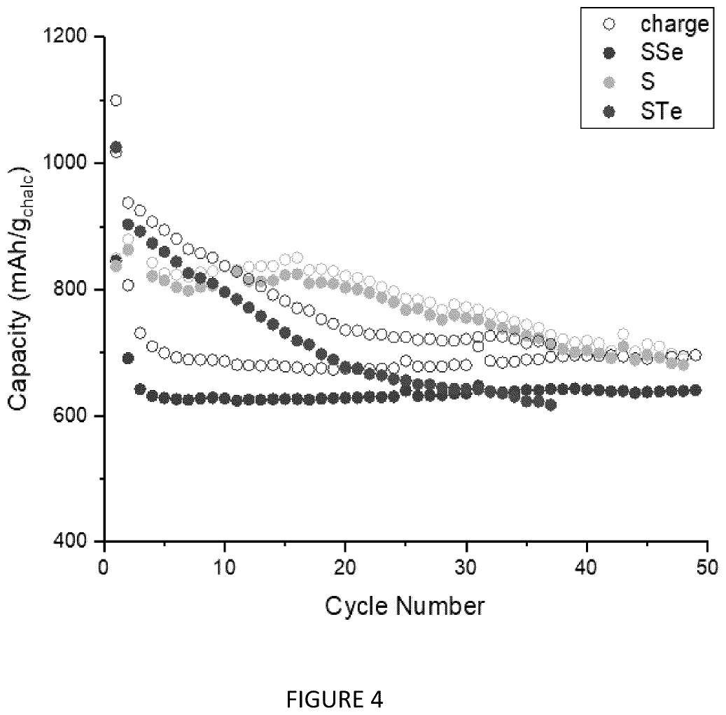

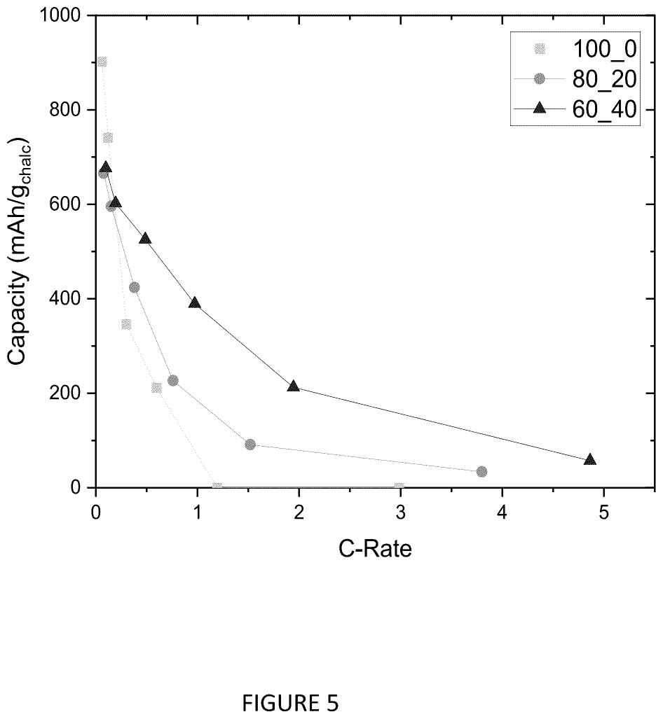

The coin cells were sealed with a crimper and then cycled with constant current (Maccor) at various rates with respect to the chalcogen content, as illustrated in FIGS. 4 and 5.

The sulfur selenium (SSe) cathode does a better job of maintaining its charge capacity in comparison to the pure sulfur cathode, as illustrated in FIG. 4. Although its overall charge capacity is less than pure sulfur at 50 cycles, the cycle trend indicates that the SSe cathode will give the most consistent charge as cycle number increases.

### Example 5

FIG. 5 illustrates the charge rate (C rate) normalized to 1 hour for the battery cells containing differing amounts of sulfur and selenium.

While the sulfur selenium blends (80_20 and 60_40) show lower lithium capacity than pure sulfur (100_0) at low charge currents, they deliver higher capacity as high currents are applied.

In essence the sulfur selenium blends store more energy than sulfur at the highest C rates as high currents are applied.

### Example 6

Instead of only S and Se, Te can also be incorporated into the chalcogen blend to further increase the electrical conductivity and/or cycling properties.

Instead of only S, Se, and Te, other elements can also be incorporated into the chalcogen component to alter the cathode electrical conductivity and/or cycling properties. Other elements that may be used include, but are not limited to: Germanium, Tin, and Antimony.

### Example 7

As an alternative to carbon paper, other carbon materials may be used, including but not limited to: Graphene, Carbon nanotubes, Buckminsterfullerenes, and Carbon black.

Instead of Lithium other metal anodes can pair with the cathodes, including but not limited to: Sodium, Potassium, Aluminum, Magnesium, and Calcium.

### Advantages and New Features

1. Our disclosure demonstrates the incorporation of S/Se blend material into battery cathodes.
2. Our new cathode involves combining chalcogen material, carbon paper, and a vapor loading process.
3. Chalcogen cathodes described herein demonstrate improved cyclability and rate capability over a pure sulfur cathode.
4. The disclosure herein allows for modulation of chalcogen ratios and vapor loading amount within carbon foam.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A chalcogenide blend for a rechargeable battery cathode material, comprising:
a chalcogen material; and
a carbon paper;
wherein the chalcogen material is incorporated into the carbon paper to form a rechargeable battery cathode material.

2. The chalcogenide blend for a rechargeable battery cathode material of claim 1,
wherein the chalcogen material is incorporated into the carbon paper via a vapor loading process to form a rechargeable battery cathode material.

3. The chalcogenide blend for a rechargeable battery cathode material of claim 2
wherein the chalcogen material is Sulfur.

4. The chalcogenide blend for a rechargeable battery cathode material of claim 3
wherein the chalcogen material is blended with one or more selected from the group consisting of Selenium, Tellurium, Germanium, Tin, and Antimony.

5. A method of making a chalcogenide blend for rechargeable battery cathode material, comprising the steps of:
blending elemental sulfur and selenium to form a Sulfur-Selenium blend chalcogen powder;
purifying the Sulfur-Selenium blend chalcogen powder; and
incorporating the Sulfur-Selenium blend chalcogen powder into a porous carbon scaffold.

6. The method of making a chalcogenide blend for rechargeable battery cathode material of claim 5, further comprising the steps of:
utilizing a multi-chamber distillation for the step of purifying the Sulfur-Selenium blend chalcogen powder.

7. The method of making a chalcogenide blend for rechargeable battery cathode material of claim 6, further comprising the steps of:
wherein the step of incorporating the Sulfur-Selenium blend chalcogen powder into a porous carbon scaffold comprises the steps of:
placing a carbon nanofoam paper electrode into a PTFE infiltration chamber;
placing the sulfur-selenium blend chalcogen powder into the PTFE infiltration chamber;
suspending a carbon nanofoam paper (CNFP) electrode via a stainless-steel mesh above the sulfur-selenium blend chalcogen powder;
sealing the PTFE infiltration chamber;
placing the PTFE infiltration chamber into a muffle furnace;
adjusting the temperature of the muffle furnace; and
allowing for vapor infiltration of the sulfur-selenium blend chalcogen powder into the carbon nanofoam paper electrode.

8. The method of making a chalcogenide blend for rechargeable battery cathode material of claim 7,
wherein the step of adjusting the temperature of the muffle furnace is such the temperature is set to 225° C. when the Sulfur-Selenium blend chalcogen powder is a 60/40 blend of Sulfur and Selenium.

9. The method of making a chalcogenide blend for rechargeable battery cathode material of claim 7, further comprising the steps of:
incorporating Tellurium into the Sulfur-Selenium blend chalcogen powder to form a Sulfur-Selenium-Tellurium blend chalcogen powder.

10. The method of making a chalcogenide blend for rechargeable battery cathode material of claim 9, further comprising the steps of:
incorporating one or more selected from the group consisting of Germanium, Tin, and Antimony.

11. The method of making a chalcogenide blend for rechargeable battery cathode material of claim 9, further comprising the steps of:
substituting the carbon for one selected from the group consisting of Graphene, Carbon nanotubes, Buckminsterfullerenes, and Carbon black.
